(19) United States
(12) Patent Application Publication
(10) Pub. No.: US 2004/0203642 A1
(43) Pub. Date: Oct. 14, 2004

(54) Population of directory search results into a wireless mobile phone

(76) Inventors: Peter Zatloukal, Duvall, WA (US); G. Eric Engstrom, Kirkland, WA (US)

Correspondence Address: SCHWABE, WILLIAMSON & WYATT, P.C., PACWEST CENTER, SUITES 1600-1900, 1211 SW FIFTH AVENUE, PORTLAND, OR, 97204, US

(21) Appl. No.: 10/161,273

(22) Filed: May 31, 2002

(51) Int. Cl. H04M 3/42

(52) U.S. Cl. 455/414.1; 455/415

(57) ABSTRACT

A wireless mobile phone is provided with a directory function to automatically save directory search results in at least one of a directory search result list and an address book of the wireless mobile phone. In various embodiments, a user of the wireless mobile phone may request for a party's phone number explicitly in a non-audible manner through a data interface, or audibly. A wireless telephone service, including its directory service, is equipped complementarily to offer and provide the wireless mobile phone with the directory search results in a selected one of a voice and a data form.

### BACKGROUND OF THE INVENTION

1. Field of the Invention

The present invention relates to the field of wireless mobile phones. More specifically, the present invention relates to methods and apparatuses related to the population of directory search results into a wireless mobile phone.

2. Background Information

Advances in computer and telecommunication technology have led to wide spread adoption of mobile client devices, in particular, wireless mobile phones. The term “wireless mobile phone” as used herein (in the specification and in the claims) refers to the class of telephone devices equipped to enable a user to make and receive calls wirelessly, notwithstanding the user's movement, as long as the user is within the communication reach of a service or base station of a wireless telephone service network. The term “wireless mobile phone” is to include the analog subclass as well as the digital subclass (of all signaling protocols).

Experience has shown that often times users of wireless mobile phones have needs to place calls to parties whose phone numbers are not known the users. Typically, under the prior art, a user with such need would call the wireless service and enlist the assistance of an operator of the service. The caller user would audibly (i.e. verbally) request the service operator to connect the caller user to the callee party of interest by name. The service operator would look up the telephone number of the callee party from a directory database, and connect the caller user to the callee party, if the callee party is found. Historically, the mobile caller user is assumed to be not in a position to record the callee party's phone number, as the caller user is most likely driving. Accordingly, no offer is made to provide the callee party's phone number to the mobile caller user. As a result, if the mobile caller user has a need to call the same callee party again at a later point of time. The same process has to be repeated, which is burdensome to the mobile caller user as well as to the wireless telephone service provider.

Recently, as the number of non-driving mobile caller users increases, an offer is often made to the mobile caller user to be audibly provided with the callee party's phone number. Typically, a verbal offer is made, while the connection to the callee party is being established, informing the caller user to denote his/her interest in hearing the callee party's phone number, by e.g. entering the “#” key. If the caller user responds by giving the requested indication, the callee party's phone number is audibly announced for the mobile caller user to hear. Presumably, the mobile caller user would write down or otherwise memorize the announced phone number. At the termination of the call, assuming if the caller user is so interested, the caller user would manually enter the recorded/memorized phone number into the mobile caller user's address book (also referred to as name list) in his/her wireless mobile phone, to facilitate speed dialing in the future, and avoid having to repeat the earlier described burdensome connection process.

However, requiring the mobile caller user to write down or otherwise memorize the directory search result, i.e. the callee party's phone number, and manually enter the recorded/memorized phone number at a later point in time, is not user friendly. Thus, an improved approach is desired.

### BRIEF DESCRIPTION OF DRAWINGS

The present invention will be described by way of exemplary embodiments, but not limitations, illustrated in the accompanying drawings in which like references denote similar elements, and in which:

FIG. 1 illustrates an overview of an environment within which the present invention may be practiced, in accordance with one embodiment;

FIGS. 2a-2c illustrate the method of the present invention, in accordance with three separate embodiments;

FIG. 3 illustrates an external view of the wireless mobile phone of FIG. 1, in accordance with one embodiment;

FIG. 4 illustrates an internal component view of the wireless mobile phone of FIG. 3, in accordance with one embodiment;

FIGS. 5a-5b illustrate a data interface suitable for use to practice the request aspect of the present invention on the wireless mobile phone, in accordance with one embodiment;

FIGS. 6a-6b illustrate the operational flow of the relevant aspect of the embedded directory function of the wireless mobile phone in support of the data interface of FIG. 5a-5b, in accordance with one embodiment;

FIGS. 7a-7b illustrate a directory search result user interface suitable for use to practice a portion of the directory search result saving aspect of the present invention on the wireless mobile phone, in accordance with one embodiment;

FIGS. 8a-8b illustrate the operational flow of the relevant aspect of the embedded directory function of the wireless mobile phone in support of the user interface of FIG. 7a-7b, in accordance with one embodiment;

FIG. 9 illustrates an example computer system suitable for use as a server of a directory service, or a workstation of a service operator of a service provider, in accordance with one embodiment;

FIG. 10 illustrates the operational flow of the relevant aspect of the directory service of FIG. 1 in support of a user request via its data interface, in accordance with one embodiment;

FIG. 11 illustrates a directory search result interface suitable for use to practice the directory search aspect of the present invention on a service operator's workstation, in accordance with one embodiment;

FIG. 12 illustrates the operational flow of the relevant aspect of the directory search function of the service operator's workstation, in support of the user interface of FIG. 11, in accordance with one embodiment; and

FIG. 13 illustrates the operational flow of the relevant aspect of the connection process of the service provider, in accordance with one embodiment.

### DETAILED DESCRIPTION OF THE INVENTION

The present invention includes a wireless mobile phone having an embedded directory function, and complementary improvements to the directory service of a wireless telephone service provider, to enable the wireless mobile phone to be automatically or semi-automatically populated with directory search results. In the following description, various aspects of the present invention will be described. However, it will be apparent to those skilled in the art that the present invention may be practiced with only some or all aspects of the present invention. For purposes of explanation, specific numbers, materials and configurations are set forth in order to provide a thorough understanding of the present invention. However, it will also be apparent to one skilled in the art that the present invention may be practiced without the specific details. In other instances, well known features are omitted or simplified in order not to obscure the present invention.

The phrase “in one embodiment” will be used repeatedly, however the phrase does not necessarily refer to the same embodiment, although it may. The terms “comprising”, “including”, “having”, and other terms of the like, are used interchangeably, and their meanings are synonymous.

### Overview

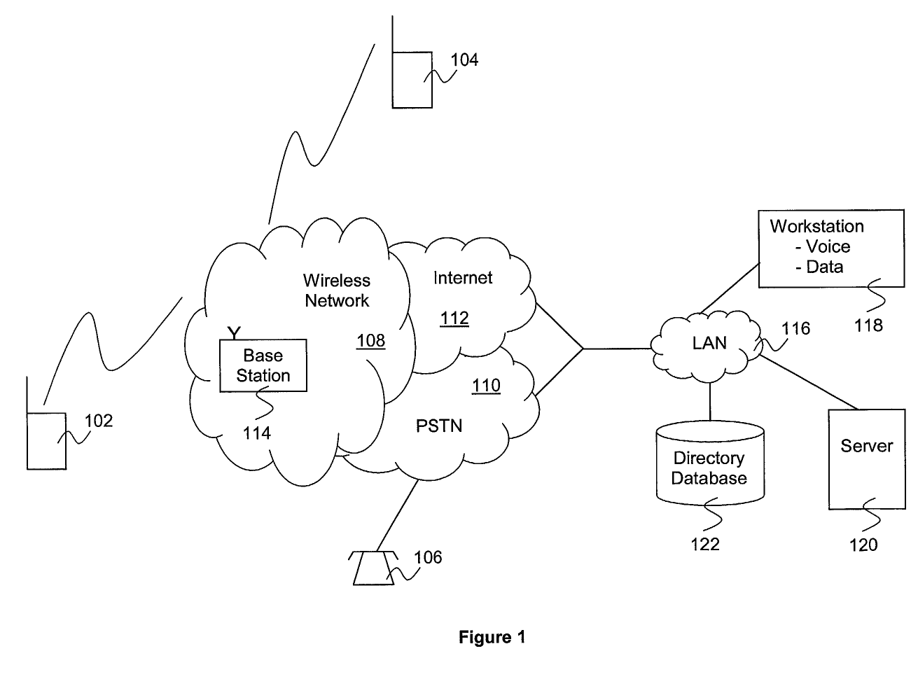

FIG. 1 illustrates an overview of an environment 100 within which the present invention may be practiced, in accordance with one embodiment. As illustrated, in environment 100 a user of a wireless mobile phone (WMP) 102 may place calls to another WMP user, such as user of WMP 104, or another line based handset user, such as user of handset 106, via wireless networks 108, Public Switched Telephone Network (PSTN) 110, and/or Internet 112, through which WMP 102 and 104 and handset 106 are communicatively coupled.

Wireless networks 108 refer to the wireless service networks of wireless telephone service providers, such as the wireless service networks offered by companies like AT&T Wireless of Redmond, Wash., Sprint of Overland Park, Kans., and so forth. Wireless networks 108 include base stations, such as base station 114, switches/routers (not shown), and so forth. PSTN 110 refers to the traditional circuit switched network of line based telephone services, such as the line circuits operated by Qwest of Denver, Colo., Bell South of Atlanta, Ga., and so forth. Internet 112 refers to the famous packet based networking backbone inter-networking private and public networks, such as intranet 116 of wireless service provider 130.

WMP 102 is advantageously provided with the embedded directory function (not shown) of the present invention. WMP 102 is communicatively coupled with its wireless service provider 103, through one or more of networks 108-112. As illustrated, wireless service provider 103 includes a number of workstations 118, a number of servers 120, and databases 122, coupled to each other through intranet 116 of wireless service provider 130. Databases 122 include various operational as well as management databases of wireless service provider 130. Databases 122 include in particular, a directory database comprising service subscribers of wireless service provider 130, as well as other telephony service providers (wireless or line based). More specifically, the directory database includes the service subscribers' names, telephone numbers, and so forth. Servers 120 are employed by wireless service provider 130 to meet its telephony as well as data processing needs. Workstations 118 are employed by the operators of wireless service provider 130 in meeting their responsibilities, e.g. client service, including but are not limited to assisting a user subscriber, such as user of WMP 102, in locating the telephone number of a party of interest, i.e. directory service.

In other words, included among the services offered by wireless service provider 130, is a directory service, through which a subscriber may locate the telephone number of a party of interest. More importantly, the directory service offered is incorporated with the teachings of the present invention, enabling the WMP of a directory service user, such as WMP 102 embedded with the directory function of the present invention, to be automatically or semi-automatically populated with the directory search result, thereby improving the overall user friendliness of the wireless telephony service offered.

Except for the teachings of the present invention incorporated, the various elements shown in FIG. 1, i.e. WMP 102-104, handset 106, networks 108-112, base station 114, workstations 118, servers 120, databases 122, and intranet 116, are all otherwise known in the art. Any one of a wide range of implementations of these elements may be employed to practice the present invention. Accordingly, except for the teachings of the present invention incorporated, the elements 102-122 are otherwise not further described.

### Method

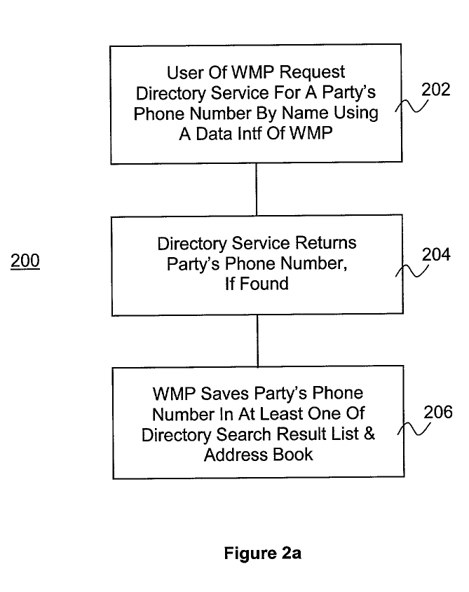

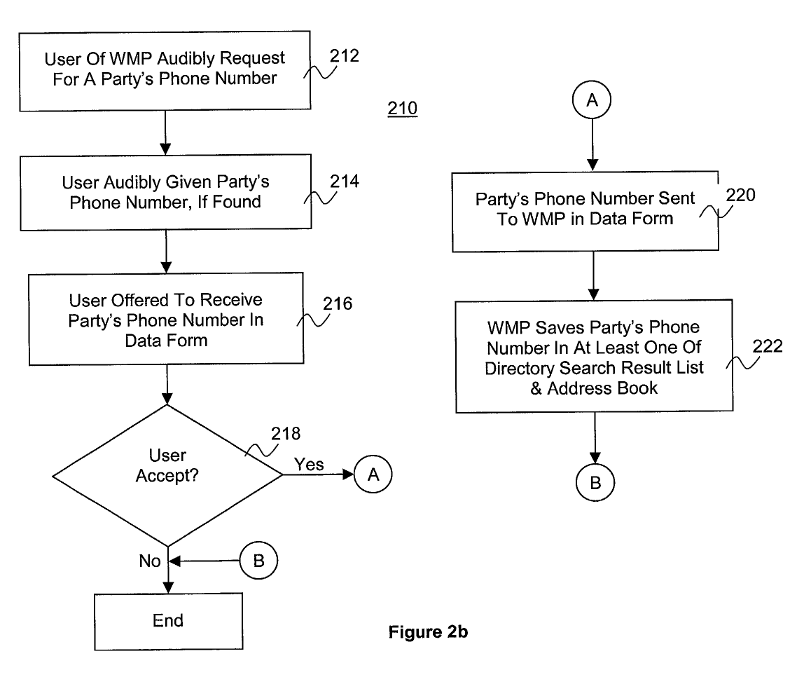

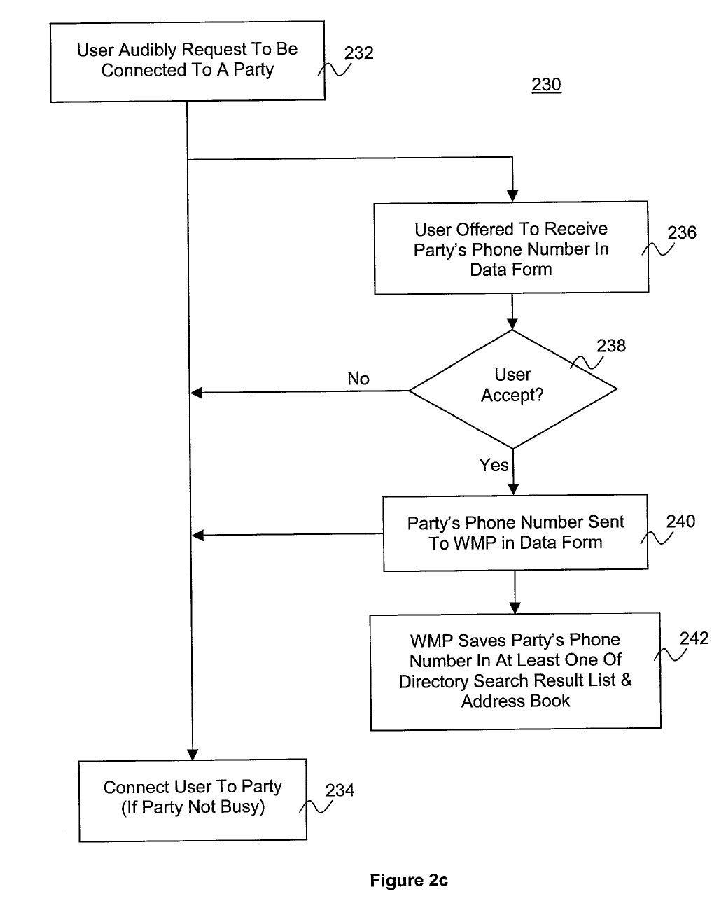

FIGS. 2a-2c illustrate the method of the present invention, in accordance with three embodiments. FIG. 2a illustrates a first embodiment, wherein a user of WMP, such as WMP 102, using a data interface of the WMP, in requesting a party's phone number from a directory service by name in a non-verbal manner, may result in the party's phone number (if found) being automatically or semi-automatically populated in the WMP. FIG. 2b illustrates a second embodiment, wherein a user of WMP, such as WMP 102, in audibly requesting a party's phone number from a service operator, may result in the party's phone number (if found) being automatically or semi-automatically populated in the WMP. Lastly, FIG. 2c illustrates a third embodiment, wherein a user of WMP, such as WMP 102, in audibly requesting a service operator in connecting the caller user to a callee party by name, may too result in the callee party's phone number (if found) being automatically or semi-automatically populated in the WMP.

Whether a named/callee party's phone number is automatically or semi-automatically populated in a WMP 102 is implementation dependent. However, to facilitate full understanding, the present invention will be described with a semi-automatic implementation, with the named/callee party's phone name being populated into a user's WMP upon consent of the user. But, it will be readily apparent from the description to follow, the present invention may be practiced with the named/callee party's phone number being populated into a user's WMP without the user's consent (i.e. the user's consent is inferred from the request actions).

As illustrated in FIG. 2a, in the first embodiment, a user of a WMP, such as WMP 102, using a data interface of WMP would contact and request a directory service, such as directory service of service provider 130, for a party's phone number by name, block 202. In response, the directory service searches accessible databases, such as database 122, and attempts to locate the phone number of the requested party, block 204. If found, the directory service returns the party's phone number in data form to the WMP of the requesting user, block 204. WMP, incorporated with the teachings of the present invention, saves the phone number in at least one of a directory search result list and/or the user's address book (or name list), on receipt of the returned party's phone number, block 206.

For the second embodiment, as illustrated in FIG. 2b, a user of a WMP, such as WMP 102, would use the standard telephony interface of WMP to contact a service operator of service provider 130, and request for a party's phone number by name, block 212. In response, the service operator searches accessible databases, such as database 122, and attempts to locate the phone number of the requested party, block 214. If found, the service operator, may as in the prior art, audibly announces the party's phone number for the requesting user. More importantly, in accordance with the present invention, the service operator would offer to return the party's phone number in data form to the WMP of the requesting user, block 216. If not accepted, no further action is taken by the service operator. However, if accepted, the service operator causes the party's phone number to be returned to the user's WMP in data form, block 220. WMP, incorporated with the teachings of the present invention, as in the first embodiment, saves the phone number in at least one of a directory search result list and/or the user's address book (or name list), on receipt of the returned party's phone number, block 222.

In alternate implementations of the second embodiment, performance of all or a portion of the operations of blocks 216-220 may be automated. That is, the service operator may be an automated service attendant. Thus, for the purpose of the present application, the term “service attendant” may comprise either a human service operator, an automated service attendant, or a combination thereof.

Further, in some embodiments, the requested phone number may also be returned audibly, and voice recognition technology is employed in the WMP to generate the returned phone number in the data form for storage instead.

For the third embodiment, as illustrated in FIG. 2c, a user of a WMP, such as WMP 102, would use the standard telephony interface of WMP to contact a service operator of service provider 130, and request to be connected to a party by name, block 232. In response, the service operator searches accessible databases, such as database 122, and attempts to locate the phone number of the requested callee party (not shown). If found, the service operator causes the caller user to be connected to the callee party, as requested (not shown). More importantly, in accordance with the present invention, while the caller user is being connected to the callee party, the service provider, such as service provider 130, in lieu of or in addition to audibly offering to announce the callee party's phone number, as in the prior art, would offer to return the party's phone number in data form to the WMP of the requesting user, block 236. If not accepted, no further action is taken, and the process continues with the completion of the connection and facilitation of the call. However, if accepted, the service provider would cause the callee party's phone number to be returned to the user's WMP in data form, block 240. Again, WMP, incorporated with the teachings of the present invention, as in the first and second embodiments, saves the phone number in at least one of a directory search result list and/or the user's address book (or name list), on receipt of the returned party's phone number, block 242.

As with the earlier embodiments, in alternate implementations, all or part of the operations described as being performed by a service operator, may be further automated to be performed by an automated service attendant. The party's phone number may be returned audibly, and voice recognition technology is employed in the WMP to generate the returned phone number in the data form for storage instead.

Directory search result list is contemplated to be a cache of directory search results, similar to the dialed call list, missed call list and received call list found in many prior art WMP. Inclusion of the directory search result list in the presently preferred embodiment advantageously serves as a staging buffer to allow the user to further intervene to save into the address book (name list), only the directory search results of strong or persistent interest. Directory search results of less interest would stay in the directory search result list until they are discarded to make space of other more recent directory search results.

Accordingly, in each of the above embodiments, the phone number of a party of interest may be populated into a user's WMP in a more user friendly manner, thereby enhancing the user experience of the WMP. Various aspects of these embodiments will be described in turn in more detail referencing the remaining figures.

### Wireless Mobile Phone

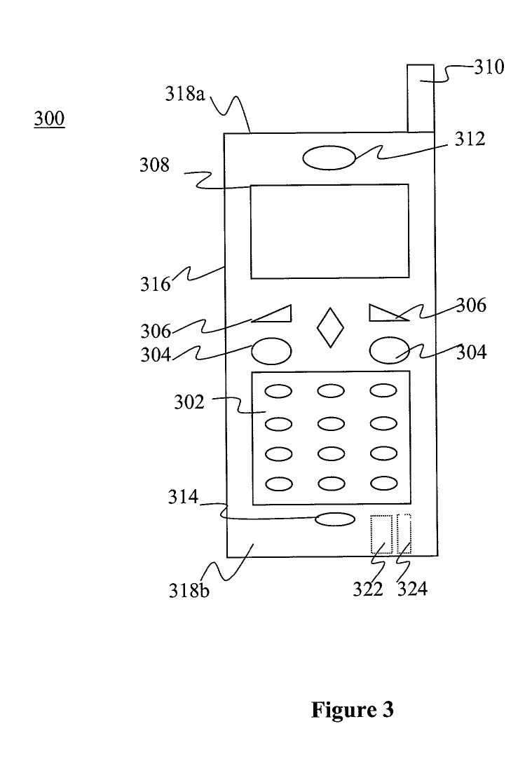

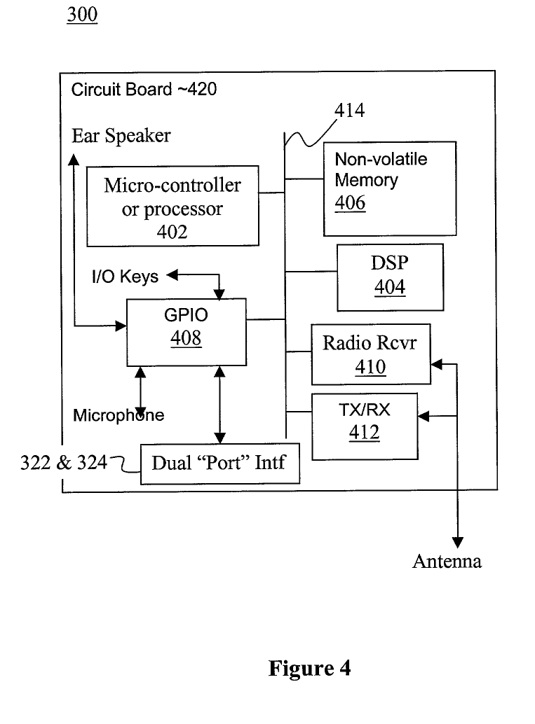

FIGS. 3-4 illustrate a wireless mobile phone 300 suitable for use to practice the present invention, in accordance with one embodiment. More specifically, FIG. 3 illustrates an external front view of the device, whereas FIG. 4 illustrates an internal component view of the device.

As illustrated in FIG. 3, for the embodiment, WMP 300 includes input keypad 302, “talk” and “end talk” buttons 304, cursor control buttons 306, display screen 308, antenna 310, ear speaker 312 and microphone 314, disposed relative to each other as shown. WMP 300 also includes palm-sized body casing 316 with top end 318a and bottom end 318b. Further, WMP 300 includes an input-output interface arrangement having at least input-output interface 322 and output interface 324. Moreover, WMP 300 is endowed with additional non-telephony functions (not shown), including in particular a radio function (not shown), and an audio player function (note shown) having non-telephony audio outputs, which are outputted through interface 324.

Interfaces 322-324 are advantageously designed in a manner that allows each of interfaces 322-324 to be singularly employed to removably attach conventional telephony headsets and audio output only headsets to wireless mobile phone 300 respectively, as well as jointly employed to removably attach the complementary headset of the present invention. Interfaces 322-324 are the subject matters of co-pending U.S. patent application <to be assigned>, filed <to be inserted>, entitled “A WIRELESS MOBILE PHONE INCLUDING A HEADSET”.

For the embodiment, antenna 310, disposed at and extruded from top end 318a, in addition to being used to send and receive telephony signals, including audio as well as control signals (in a modulated or digitized manner), is also being used to receive radio signal with radio programming. In alternate embodiments, a separate antenna may be employed to receive radio programming. In yet other alternate embodiments, antenna 310 may be disposed at and extruded from bottom end 318b, as described in co-pending U.S. patent application Ser. No. 09/767,526, filed Jan. 22, 2001, entitled “A WIRELESS MOBILE PHONE WITH INVERTED PLACEMENT OF ANTENNA AND INPUT KEYPAD”.

For the embodiment, each of the other elements 302-308 and 312-314 performs its conventional function known in the art. For example, input keypad 302, disposed near bottom end 318b, facilitates a user in providing numeric or alphanumeric inputs, whereas “talk” and “end talk” buttons 304, disposed in the mid-section of phone 300, are used to start and end a call. Display screen 308, disposed near top end 318a, is used to echo numeric or alphanumeric inputs entered by a user, as well as to display various menu options, control information, and so forth. Cursor control buttons 306, disposed in the mid-section of phone 300, are used to facilitate a user in making various menu and/or option selections. Microphone 314, also disposed near bottom end 318b, is used to facilitate the user in providing audio input, whereas ear speaker 312, disposed near top end 318a, is used to facilitate outputting for the user, received audio. These elements and their operations will not be further described.

However, in alternate embodiments, input keypad 302 may also be equipped to enable a user to enter data and/or commands through stroking patterns, as described in co-pending U.S. patent application Ser. No. 09/767,197, filed Jan. 22, 2001, entitled “A WIRELESS MOBILE PHONE WITH KEY STROKING BASED INPUT FACILITIES”.

Further, in alternate embodiments, wireless mobile phone 300 may also be endowed with other functionalities, such as encoded data entry facilities as described in co-pending U.S. patent application Ser. No. 09/975,287, filed Oct. 10, 2001, entitled “WIRELESS MOBILE PHONE WITH ENCODED DATA ENTRY FACILITIES”, or luminescent signaling display capability as described in co-pending U.S. patent application Ser. No. 09/908,118, filed Jul. 17, 2001, entitled “LUMINESCENT SIGNALING DISPLAYS UTILIZING A WIRELESS MOBILE COMMUNICATION DEVICE”.

As illustrated in FIG. 4, internally, wireless mobile phone 300 includes elements found in conventional mobile client devices, such as micro-controller/processor 402, digital signal processor (DSP) 404, non-volatile memory 406, general purpose input/output (GPIO) interface 408, and transmit/receive (TX/RX) 412 (also known as a transceiver), coupled to each other via bus 414, and disposed on a circuit board 420. Additionally, in accordance with the present invention, wireless mobile phone 400 further includes the earlier described dual “port” interface 322 and 324, which as illustrated is coupled to GPIO 408. Further, for the embodiment, wireless mobile phone 300 also includes radio receiver 410 coupled to antenna 310, and a software implementation of an MP3 player (not shown). More importantly, for the embodiment, wireless mobile phone 300 is endowed with a software implementation of a directory function of the present invention, to be described more fully below. As alluded to earlier, in alternate embodiment, wireless mobile phone 300 may also include voice recognition technology (not shown).

Except for the directory function provided to wireless mobile phone 300, to be described more fully below, each of these elements 402-414 performs its conventional function known in the art, and is intended to represent a broad range of such element and its equivalents. In particular, TX/RX 412 may support one or more of any of the known signaling protocols, including but are not limited to CDMA, TDMA, GSM, and so forth. Further TX/RX 412 may be implemented using separate transmitter and receiver.

Accordingly, elements 402-414 will not be further described.

### Data Interface and Corresponding Operating Logic of Directory Function of WMP

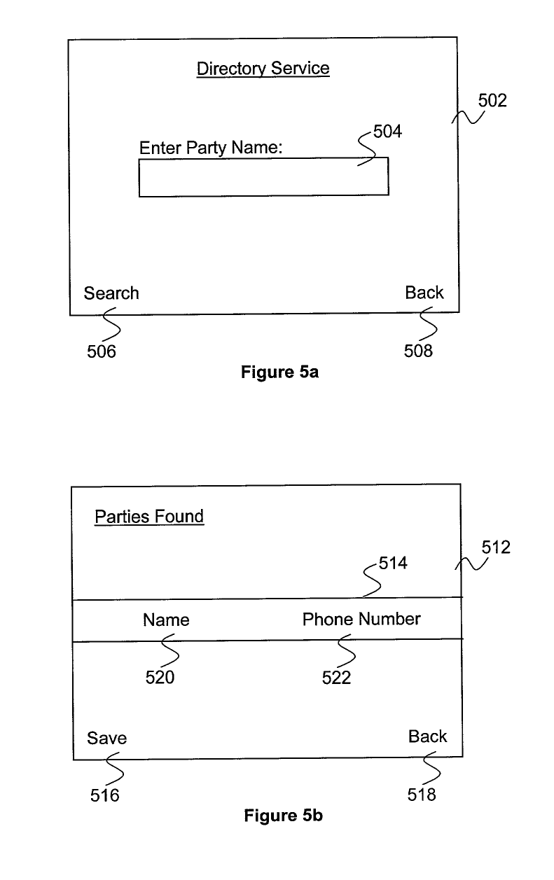

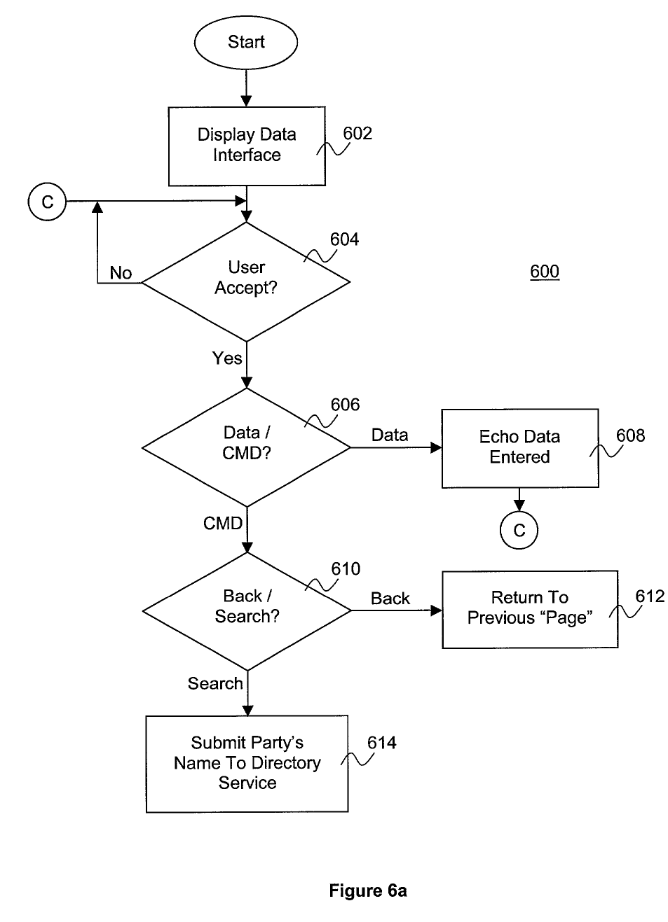

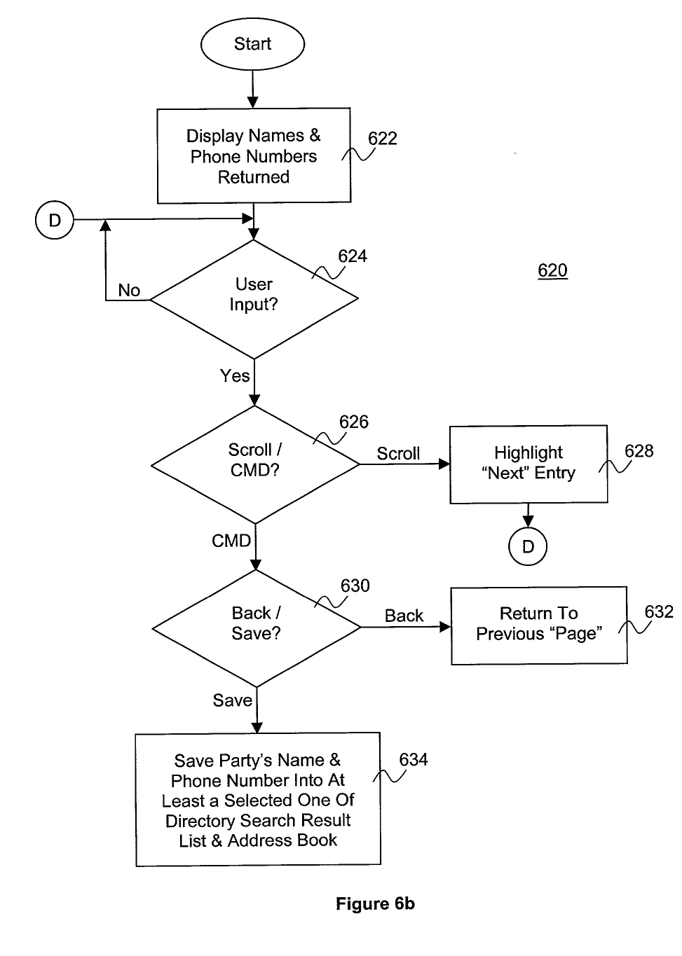

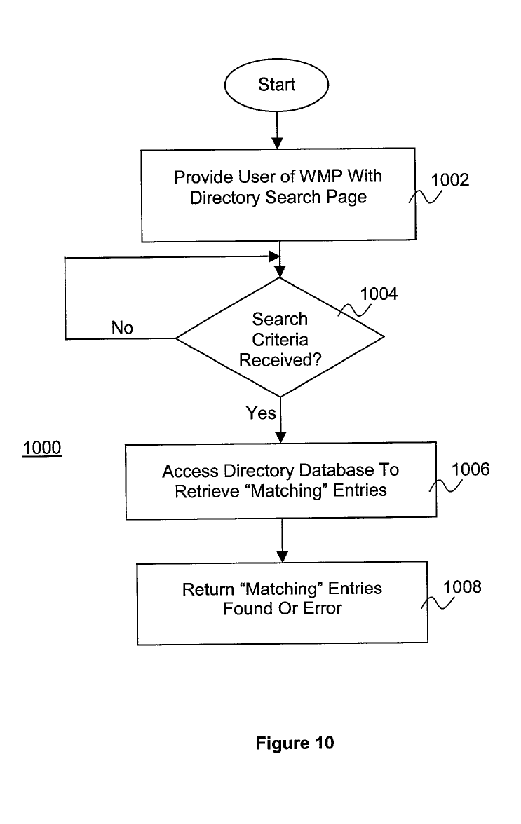

FIGS. 5a-5b illustrate a data interface suitable for use to practice the requesting aspect of the present invention on a WMP, in accordance with one embodiment; and FIGS. 6a-6b illustrate the corresponding logic of the directory function of the present invention provided to the WMP, in support of the data interface of FIG. 5a-5b, in accordance with one embodiment. The embodiment assumes the data interface is integrally provided by the embedded directory function of the WMP. However, as will be described with reference to FIG. 10, the data interface may also be provided by the directory service of service provider 130 instead.

As illustrated in FIG. 5a, the data interface includes screen 502 having data field 504 to facilitate a user of the WMP to enter all or a portion of the name of a party of interest. For the embodiment, screen 502 further includes “Search” command option 506 and “Back” command option 508. “Back” command option 508 is used to facilitate the user in denoting the desire to return to a previous screen, whereas “Search” command option 506 is employed to facilitate the user in submitting a request to the directory service of the service provider for the phone number of the partially/fully named party. “Search” command option 506 and “Back” command option 508 may for example be selected using corresponding control buttons 306.

FIG. 5b illustrates an example screen 512 listing one or more name and phone number pairs 514 found by the directory service of the service provider to be matching the submitted criteria (i.e. the partially/fully named party of interest), with one of the name and phone pair 514 highlighted as the current focus pair. The current focus may be moved to other listed pairs above or below the current focus pair, using for example the scroll button disposed in between control buttons 306. Similarly, screen 512 further includes “Save” command option 516 and “Back” command option 518. “Back” command option 518 is used to facilitate the user in denoting the desire to return to a previous screen, whereas “Save” command option 516 is employed to facilitate the user in saving the name and phone number pair of the current focus into at least a directory search result list and an addressable book (name list) of the WMP.

As illustrated in FIG. 6a, in support of the above described data interface, the directory function of the present invention provided to the WMP displays the data interface on request, block 602. Thereafter, the directory function awaits for user inputs, block 604. Upon receipt of a user input, the directory function determines if the received user input is data entered into field 504 or the selection of one of command options 506-508. If the received user input is data entered into field 504, the directory function echoes the data entered accordingly, block 608, and continues back at block 604.

On the other hand, if the received user input is one of commands 506-508, the directory function further determines if it is “Search” command 506 or “Back” command 508 that has been selected, block 610. If it is the “Back” command 508 that was selected, the directory function returns to the previous display screen accordingly, block 612. However, if it is “Search” command 506 that was selected, the directory function submits the entered criteria, i.e. the data entered into name field 504 to request the directory service of the service provider for the phone number of the partially/fully named party, block 614.

In one embodiment, the request is submitted as a message in accordance with the Wireless Access Protocol (WAP). In alternate embodiments, other message and/or communication protocols, such as Wireless IP, may be employed instead.

As illustrated in FIG. 6b, upon receipt of one or more name and phone number pairs returned in response to the submitted phone number request, the directory function causes the returned name and phone number pairs to be displayed, block 622. As before, upon displaying the name and phone number pairs, the directory function awaits for further user inputs, block 624. Upon receipt of a user input, the directory function determines if the received user input is a selection of the scrolling control button, or the selection of one of command options 506-508. If the received user input is the selection of the scrolling button, the directory function modifies the current focus of the displayed name and phone number pair accordingly, block 626, and continues back at block 624.

On the other hand, if the received user input is one of commands 516-518, the directory function further determines if it is “Save” command 516 or “Back” command 518 that has been selected, block 630. If it is the “Back” command 518 that was selected, the directory function returns to the previous display screen accordingly, block 632. However, if it is “Save” command 516 that was selected, the directory function submits the save the name and phone number pair of the current focus into at least one of the directory search result list and the address book (name list) of the WMP, block 634.

In one embodiment, the name and phone number pair is also returned as a message in accordance with the Wireless Access Protocol (WAP). Similarly, in alternate embodiments, other message and/or communication protocols, such as Wireless IP, may be employed instead.

### Directory Search Result List and Corresponding Operating Logic of Directory Function of WMP

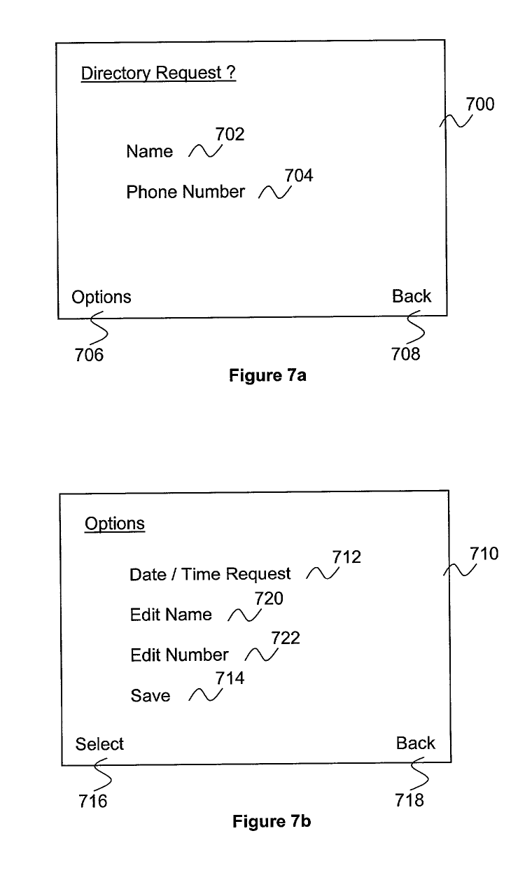

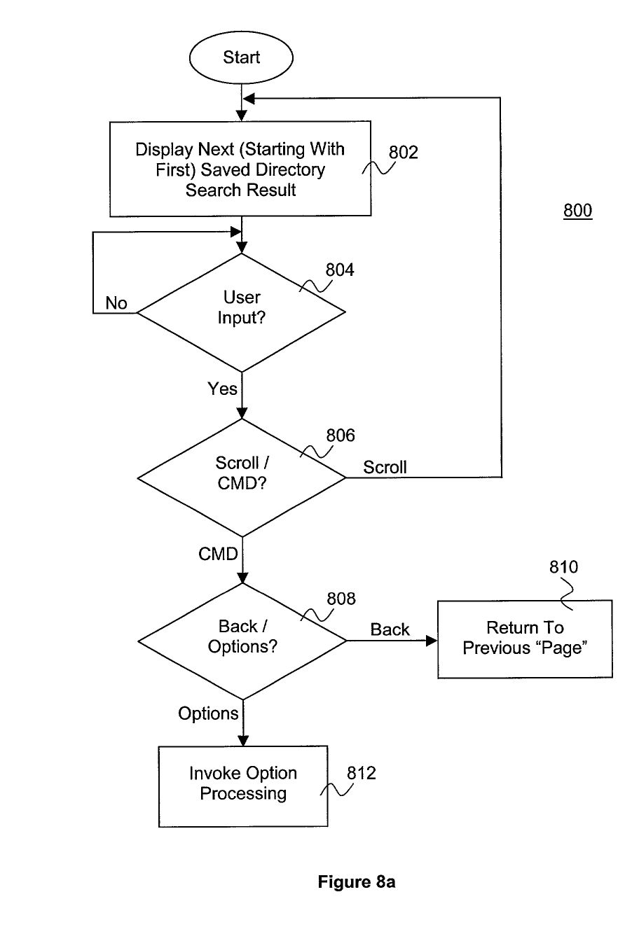

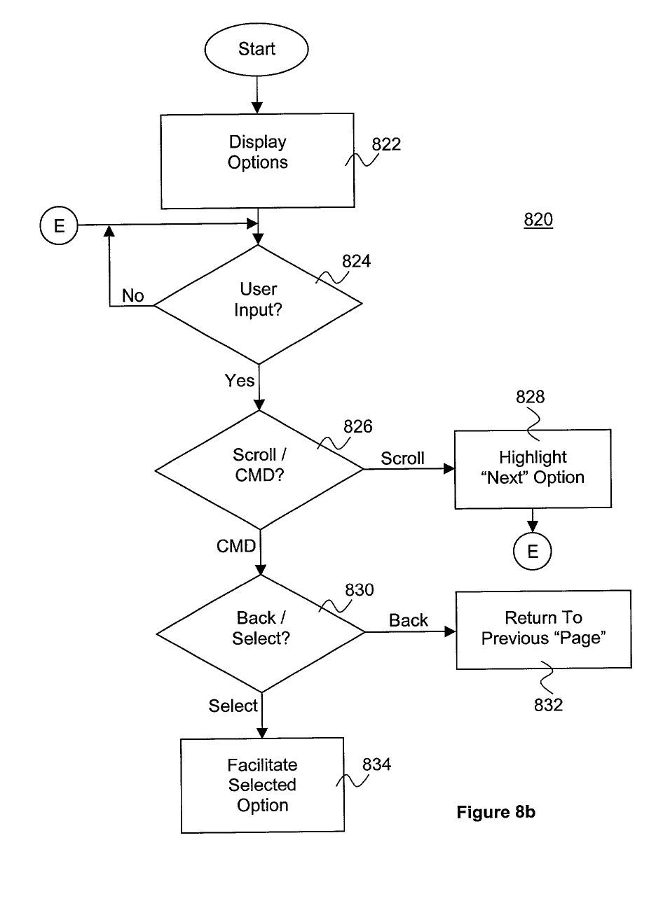

FIGS. 7a-7b illustrate a directory search result interface suitable for use to practice the directory search result save aspect of the present invention on a WMP, in accordance with one embodiment; and FIGS. 8a-8b illustrate the corresponding logic of the directory function of the present invention provided to the WMP, in support of the directory search result interface of FIG. 7a-7b, in accordance with one embodiment.

As illustrated in FIG. 7a, the directory search result interface includes screen 700 listing one of the directory search results saved into the directory search result list. For the embodiment, screen 700 further includes “Options” command 706 and “Back” command option 708. “Back” command option 708 is used to facilitate the user in denoting the desire to return to a previous screen, whereas “Options” command option 706 is employed to facilitate the user in requesting for the processing options available for the currently displayed directory search result. As the earlier described data interface, “Options” command option 706 and “Back” command option 708 may for example be selected using corresponding control buttons 306.

FIG. 7b illustrates an example screen 710 listing the one or more processing options available for processing the currently displayed name and phone number pair 702-704. For the embodiment, these options include an option 712 to list the date and time the directory search was made, an option 720 to edit the name portion of the name and phone number pair, an option 722 to edit the phone number portion of the name and phone number pair, and a “Save” option to save the name and phone number pair into the address book (name list) of the WMP.

For the embodiment, it is assumed that when a named/callee party's phone number is provided in data form, the name and phone number pair is also provided with other control information, such as the date and time the directory search request is made.

Option 720 is particularly useful in facilitating a user in modifying the name portion to his/her liking, e.g. changing the formal name of the subscriber to a nickname known to the user. Option 722 is particular useful in facilitating a user in modifying the phone number portion, e.g. changing a returned general number to a particularized direct dial extension of the named party.

Screen 710 further includes “Sel” command option 716 and “Back” command option 718. “Back” command option 718 is used to facilitate the user in denoting the desire to return to a previous screen, whereas “Sel” command option 716 is employed to facilitate the user in selecting the option of the current focus. As screen 512, the current focus may be moved to a processing option above or below the processing option of the current focus using the earlier described scroll button, and commands 716-718 may be selected using corresponding ones of control buttons 306.

As illustrated in FIG. 8a, in support of the above described directory search result interface, the directory function of the present invention provided to the WMP displays the “next” (starting with the first) of the saved directory search results, block 802. Thereafter, the directory function awaits for user inputs, block 804. Upon receipt of a user input, the directory function determines if the received user input is the selection of the scroll button or the selection of one of command options 706-708. If the received user input is the selection of the scroll button, the directory function displays the “next” saved directory search result accordingly, block 802, and continues back at block 804.

On the other hand, if the received user input is one of commands 706-708, the directory function further determines if it is “Options” command 706 or “Back” command 578 that has been selected, block 808. If it is the “Back” command 708 that was selected, the directory function returns to the previous display screen accordingly, block 810. However, if it is “Options” command 706 that was selected, the directory function invokes the logic in support of screen 710, block 812.

As illustrated in FIG. 8b, in response to a user's selection of “Options” command 706 of screen 700, the directory function causes the processing options to be displayed, block 822. As before, upon displaying the processing options, the directory function awaits for further user inputs, block 824. Upon receipt of a user input, the directory function determines if the received user input is a selection of the scrolling control button, or the selection of one of command options 716-718. If the received user input is the selection of the scrolling button, the directory function modifies the current focus of the displayed processing options accordingly, block 828, and continues back at block 824.

On the other hand, if the received user input is one of commands 716-718, the directory function further determines if it is “Sel” command 716 or “Back” command 718 that has been selected, block 830. If it is the “Back” command 718 that was selected, the directory function returns to the previous display screen accordingly, block 832. However, if it is “Sel” command 716 that was selected, the directory function invokes the subroutines causing the selected processing option to be effectuated accordingly, block 634.

The various option processing may be effectuated in any one of a number of implementation manners, which are all within the ability of those skilled in the art; accordingly will not be further described.

### Example Computer System

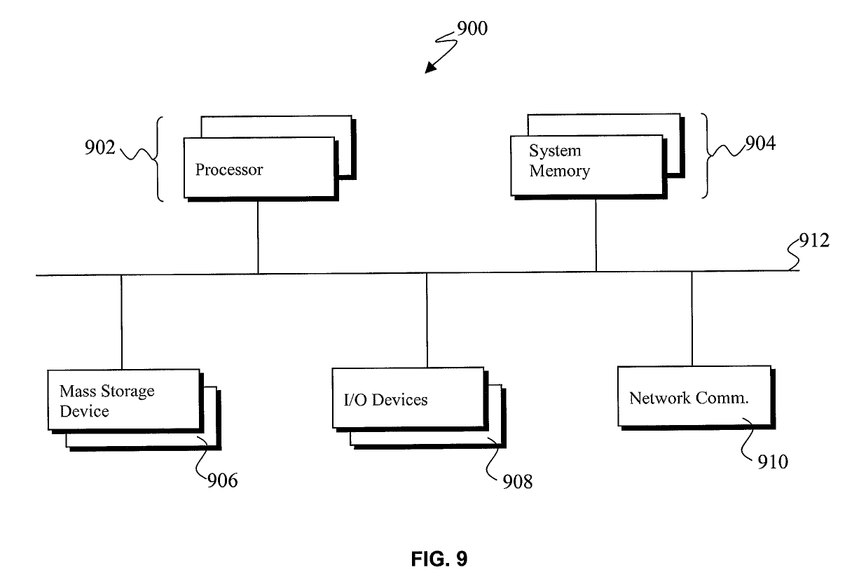

FIG. 9 illustrates one embodiment of an exemplary digital system suitable for use to practice the present invention, either as a workstation 118 of a service operator or a server 120 of service provider 130. As a workstation 118, digital system 900 may be a desktop computer system, a laptop computer system, and so forth. As a server 120, digital system 900 may be a single or a cluster of computer systems. As shown, exemplary digital system 900 includes one or more processors 902 and system memory 904. Additionally, system 900 includes mass storage devices 906 (such as diskette, hard drive, CDROM and so forth), input/output devices 908 (such as keyboard, cursor control and so forth) and communication interfaces 910 (such as network interface cards, modems and so forth). The elements are coupled to each other via system bus 912, which represents one or more buses. In the case of multiple buses, the buses are bridged by one or more bus bridges (not shown). Each of these elements performs its conventional functions known in the art. In particular, system memory 904 and mass storage 906 are employed to store a working copy and a permanent copy of the programming instructions implementing the teachings of the present invention (i.e. the functionalities of the present invention provided to a workstation of a service operator or the functionalities of present invention provided to the directory service of the service provider). The permanent copy of the programming instructions may be loaded into mass storage 906 in the factory, or in the field, as described earlier, through a distribution medium (not shown) or through communication interface 910 (from a distribution server (not shown). The constitution of these elements 902-912 are known, and accordingly will not be further described.

### Directory Service

FIG. 10 illustrates the operational flow of the relevant portion of the directory service of service provider 130, in support of the present invention, in accordance with one embodiment. The embodiment assumes it is the responsibility of the directory service of the service provider 130 to provide the data interface to the WMP for the user to submit a request for the phone number of a named party. For the embodiment described with reference to FIGS. 5a-5b and 6a-6b, where the data interface is integrally provided by the embedded directory function of WMP, process 1000 may be practiced in an abridged manner, involving operations of blocks 1006-1008 instead.

As illustrated, for the embodiment, upon contacted by a WMP, e.g. by virtue of a browser of the WMP opening a connection to the directory service through the specification of a uniform resource identifier (URI) identifying the directory service, the directory service provides the user of the WMP with the data interface, e.g. a data interface similar to the one described with references to FIG. 5a-5b, block 1002. Thereafter, the directory service awaits for the submission of the search criteria, block 1004.

Upon receipt of a request for a named party's phone number, i.e. the search criteria, the directory service accesses the accessible directory databases, such as databases 122, and retrieves the “matching” entries, i.e. subscriber name and phone number pairs that match the submitted “name” of the party (which as described earlier may be partially or fully specified), block 1006. If at least one matching subscriber name and phone number pair is found, the directory service returns the matching subscriber name and phone number pair found, block 1008.

In various embodiments, if no matching subscriber name and phone number pair is found, an error is returned instead.

### Audible Request and Support Logic for Service Operator

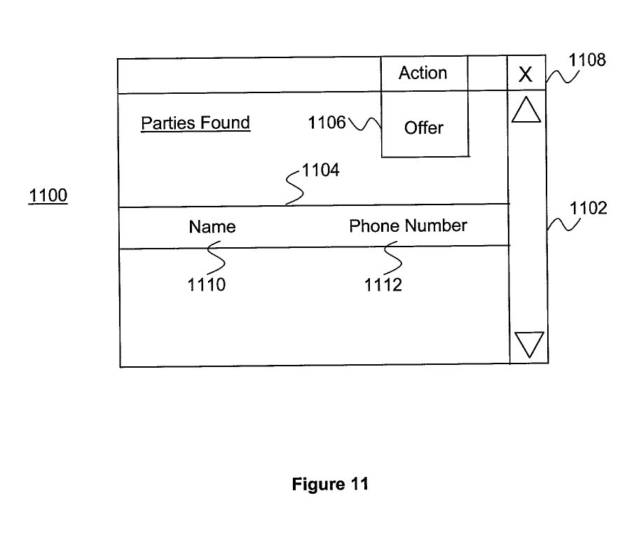

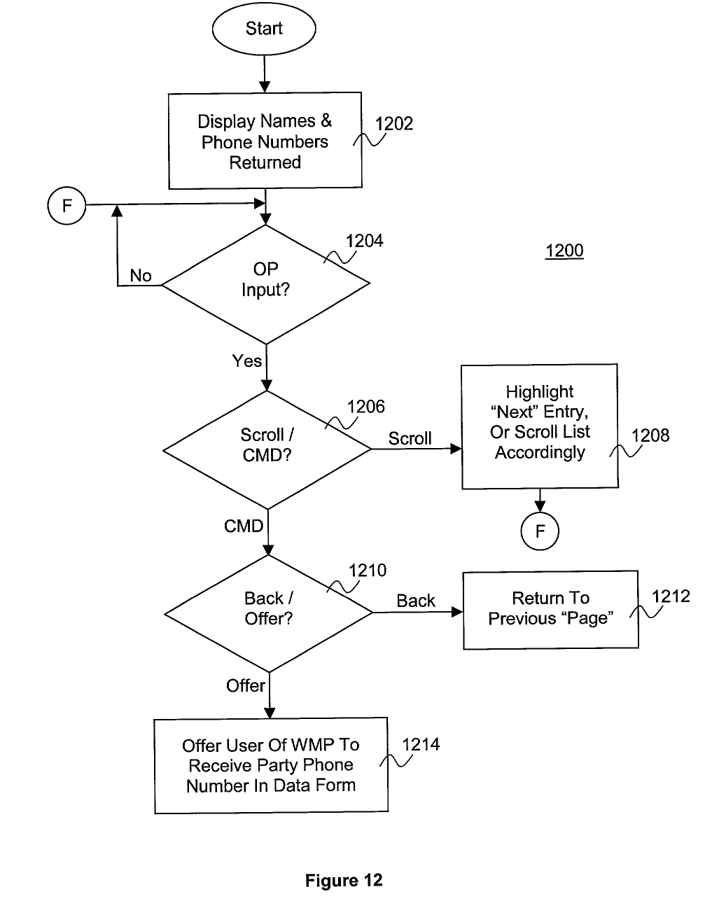

FIG. 11 illustrates a service operator interface suitable for use to practice the service operator aspect of the present invention on a service operator workstation, in accordance with one embodiment. More specifically, the service operator interface is suitable for use by the service operator in offering a user of the WMP to receive a located party's phone number. The portion of the service operator interface through which a service operator may enter the search criteria to search a party's phone number audibly requested by a user of the WMP may be implemented similar to the data interface of FIG. 5a-5b; accordingly will not be described. FIG. 12 illustrates the supporting logic provided to a service operator workstation in support of the service operator interface of FIG. 11.

As illustrated in FIG. 11, for the embodiment, interface 1100 enumerates the subscriber name and phone number pairs 1104 found, with one the enumerated pair 1104 highlighted (i.e. the current focus). The current focus may be changed through selection of the up and down arrow key of the keyboard of the service operator's workstation. Interface 1100 includes a scroll bar 1102 for scrolling the enumerated list in the event the list is too long to be fully displayed with one display screen, and icon 1108 for closing the interface. More importantly, interface 1100 includes a selectable “offer” command 1106 for causing an offer to be made to a user of a WMP to accept the subscriber name and phone pair of the current focus in data form.

As illustrated in FIG. 12, upon invocation, the operating logic in support of interface 1100, as alluded to earlier, displays the subscriber name and phone pairs returned from a query to the accessible directory databases for the named party audibly requested by the user of the WMP, block 1202. Thereafter, the operating logic awaits for further service operator inputs, block 1204. Upon receipt of a service operator input, the operating logic determines if the received service operator input is the selection of a scrolling key or the scroll bar 1102, or the selection of one of supported commands. If the received service operator input is the selection of a scrolling key or the scroll bar 1102, the operating logic changes the current focus and/or scroll the displayed list accordingly, block 1208, and continues back at block 1204.

On the other hand, if the received service operator input is one of the supported commands, the directory function further determines the command selected, in particular, whether the closing of interface command 1108 or offer command 1106 is selected, block 1210. If it is the closing icon 1108 that was selected, the operating logic closes interface 1100 and returns to a previous display screen accordingly, block 1212. However, if it is “offer” command 1106 that was selected, the operating logic offers the user of the WMP to receive the named party's phone number in data form (which may be in addition to or in lieu of the audible offer of the prior art). If other commands are selected instead, these other commands may be processed in conventional application dependent manners (not shown).

In one embodiment, the offer may be made audibly as the prior art audible offer to hear the named party's phone number. Similarly, acceptance of the offer may be conveyed by the user of the WMP through the selection of a special key, e.g. the “#” key.

Upon receipt of the acceptance indication (not shown), the operating logic provides the named party's phone number in data form to the user's WMP. As other earlier described communications, the named party's phone number may be provided with other control information, such as date and time of request, and the provision may be made in accordance with WAP or other messaging/communication protocols of like kind. Further, in one embodiment, the messaging signals may be encoded and sent to the WMP interleaved with other audible telephony signals between the service operator and the user. Simultaneous voice and data encoding within the same signal stream is known in the art; accordingly will not be further described.

### Implicit Request and Corresponding Support Logic

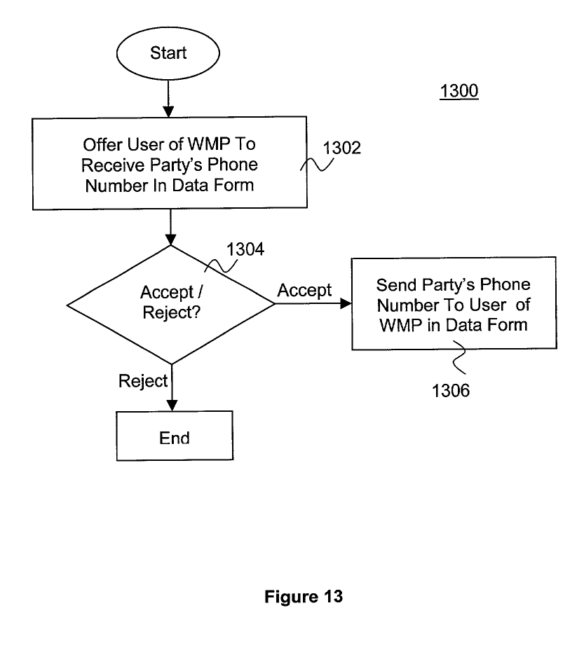

FIG. 13 illustrates the operational flow of the relevant portion of the operating logic of the service provider for connecting a WMP to a callee party. Connection of a WMP to a callee party is known in the art; accordingly that portion of the operating logic will not be described. As alluded to earlier and illustrated in FIG. 13, under the present invention, as part of the connection process connecting a WMP to a callee party, the WMP is offered to receive the callee party's phone number in data form, block 1302. Thereafter, if the user of the WMP conveys acceptance of the offer, in accordance with the specified manner (e.g. selection of the “#” key), the operating logic of the connection process sends the callee party's phone number to the caller user's WMP, block 1306.

For the embodiment, if the acceptance indicator is not accepted within a predetermined elapsed time since the offer, the offer is deemed to have been rejected. Under the circumstance, the operating logic of the connection process takes no further action, as far as providing the named party's phone number to the caller user's WMP is concerned.

As other earlier described embodiments, the offer is preferably conveyed audibly, as the prior art offers to hear the named party's phone number, and the named party's phone number is preferably sent in accordance with WAP, with the messaging signals encoded and interleaved with other audio signals of the call, or other wireless communication protocols, such as Wireless IP.

### Conclusion and Epilog

Accordingly, an improved method to populate directory search results in a wireless mobile phone, including improvements to a service provider and to wireless mobile phones have been described. While the present invention has been described in terms of the above illustrated embodiments, in particular, in term of wireless mobile phones, those skilled in the art will recognize that the invention is not limited to the embodiments described. The present invention can be practiced with modification and alteration within the spirit and scope of the appended claims, or on other wireless communication devices. Thus, the description is to be regarded as illustrative instead of restrictive on the present invention.

What is claimed is:

1. In a wireless mobile phone, a method of operation comprising:
facilitating a user of said wireless mobile phone in using said wireless mobile phone to perform a selected one of requesting a party's phone number from a directory service, and requesting a service attendant to connect said user to a party by name;
facilitating receipt of said party's phone number in a selected one of a voice and a data form; and
facilitating said user in saving said received party's phone number in said wireless mobile phone without having to have said user manually enter said party's phone number into said wireless mobile phone.

2. The method of claim 1, wherein said facilitating of said user of said wireless mobile phone in using said wireless mobile phone to request a party's phone number from a directory service comprises facilitating said user of said wireless mobile phone audibly requesting said party's phone number from an attendant of said directory service, through telephony means of said wireless mobile phone.

3. The method of claim 1, wherein said facilitating of said user of said wireless mobile phone in using said wireless mobile phone to request a party's phone number from a directory service comprises facilitating said user of said wireless mobile phone requesting said party's phone number from said directory service, through a data interface of said wireless mobile phone.

4. The method of claim 1, wherein said facilitating of said user of said wireless mobile phone in using said wireless mobile phone to request a service attendant to connect said user to a party by name comprises facilitating said user of said wireless mobile phone audibly requesting said service attendant of said connection, through telephony means of said wireless mobile phone.

5. The method of claim 4, wherein said method further comprises facilitating said user in accepting an offer from the service attendant to receive said party's phone number from the service attendant.

6. The method of claim 1, wherein said facilitating of receipt of said party's phone number in a data form comprises facilitating receipt of a data packet having said party's phone number as a part of a data payload portion of said received data packet.

7. The method of claim 6, wherein said data payload portion of said received data packet further includes identification information identifying said party as being affiliated with said included phone number.

8. The method of claim 6, wherein
said facilitating of said user of said wireless mobile phone in using said wireless mobile phone to request a party's phone number from a directory service comprises facilitating said user of said wireless mobile phone audibly requesting said party's phone number from an attendant of said directory service, through telephony means of said wireless mobile phone;
said data packet is encoded among audio signals sent from said attendant to said wireless mobile phone; and
said facilitating of receipt of said party's phone number in data form comprises decoding said data packet from said audio signals.

9. The method of claim 6, wherein
said facilitating of said user of said wireless mobile phone in using said wireless mobile phone to request a service attendant to connect said user to a party by name comprises facilitating said user of said wireless mobile phone audibly requesting said service attendant of said connection, through telephony means of said wireless mobile phone;
said data packet is encoded among audio signals sent to said wireless mobile phone; and
said facilitating of receipt of said party's phone number in data form comprises decoding said data packet from said audio signals.

10. The method of claim 6, wherein
said facilitating of said user of said wireless mobile phone in using said wireless mobile phone to request a service attendant to connect said user to a party by name comprises facilitating said user of said wireless mobile phone audibly requesting said service attendant of said connection, through telephony means of said wireless mobile phone; and
said facilitating of receipt of said party's phone number in a data form comprises facilitating receipt of said data packet from the service attendant over another connection connecting the service attendant to said wireless mobile phone, automatically established at a subsequent point in time after termination of the requested connection to said party.

11. The method of claim 1, wherein said facilitating of receipt of said party's phone number in a selected one of a voice and a data form comprises facilitating receipt of said party's phone number in a voice form, and the method further comprises automatically generating said party's phone number in said data form.

12. The method of claim 1, wherein said saving of said party's phone number in said wireless mobile phone comprises saving said party's phone number in a directory search result list of said wireless mobile phone.

13. The method of claim 12, wherein said method further comprises facilitating saving of said party's phone number from said directory search result list of said wireless mobile phone into an address book of said wireless mobile phone.

14. The method of claim 1, wherein said saving of said party's phone number in said wireless mobile phone comprises saving said party's phone number into an address book of said wireless mobile phone.

15. A wireless mobile phone comprising:
telephony means for facilitating a user of said wireless mobile phone to engage in a telephone call with another party, including engaging in a selected one of audibly requesting a first party's phone number from a directory service, and audibly requesting a service attendant to connect said user to said first party by name; and
directory means in cooperation with said telephony means for facilitating receipt of said first party's phone number in a selected one of a voice and a data form, and saving said received first party's phone number in said wireless mobile phone, without having to have the user enter the first party's phone number.

16. The wireless mobile phone of claim 15, wherein said wireless mobile phone further comprises data interface means for facilitating said user of said wireless mobile phone in non-audibly requesting said first party's phone number from said directory service.

17. The wireless mobile phone of claim 15, wherein said telephony means is further equipped to facilitate said user in accepting an offer from the service attendant to receive said first party's phone number from the service attendant.

18. The wireless mobile phone of claim 15, wherein said telephony and directory means are equipped to facilitate receipt of a data packet having said party's phone number as a part of a data payload portion of said received data packet.

19. The wireless mobile phone of claim 18, wherein said data payload portion of said received data packet further includes identification information identifying said party as being affiliated with said included phone number.

20. The wireless mobile phone of claim 18, wherein said data packet is encoded among audio signals sent to said wireless mobile phone, and said telephony means include decode means to decode said data packet from said audio signals.

21. The wireless mobile phone of claim 18, wherein said telephony and directory means are equipped to facilitate receipt of said data packet from the service attendant over another connection connecting the attendant service to said wireless mobile phone, automatically established at a subsequent point in time after termination of the requested connection to said first party.

22. The wireless mobile phone of claim 15, wherein said directory means further comprises voice recognition means in generating said party's phone number in said data form, when said party's phone number is received in said voice form.

23. The wireless mobile phone of claim 15, wherein said directory means is equipped to save said party's phone number in a directory search result list.

24. The wireless mobile phone of claim 23, wherein said directory means is further equipped to facilitate saving said first party's phone number from said directory search result list into an address book.

25. The wireless mobile phone of claim 15, wherein said directory means is equipped to save said party's phone number into an address book of said wireless mobile phone.

26. A wireless mobile phone comprising:
data interface means for facilitating a user of said wireless mobile phone in non-audibly requesting a party's phone number from said directory service; and
directory means in cooperation with said data interface means for facilitating receipt of said party's phone number in a data form, and saving said received first party's phone number in at least a selected one of a directory search result list and an address book.

27. The wireless mobile phone of claim 26, wherein said data interface and directory means are equipped to facilitate receipt of a data packet having said party's phone number as a part of a data payload portion of said received data packet.

28. The wireless mobile phone of claim 27, wherein said data payload portion of said received data packet further includes identification information identifying said party as being affiliated with said included phone number.

29. The wireless mobile phone of claim 28, wherein said directory means is equipped to facilitate first saving said party's phone number in said directory search result list, and then facilitating said party's phone from said directory search result list into an address book, upon requested.

30. An apparatus comprising:
a selected one of means to receive from a wireless mobile phone an audible request for a party's phone number, and means to receive from a wireless mobile phone an audible request to connect said wireless mobile phone to a party by name; and
means to provide to said wireless mobile phone said party's phone number in a selected one of a voice and a data form to allow said wireless mobile phone to save said party's phone number.

31. The apparatus of claim 30, wherein said apparatus comprises said means to receive from a wireless mobile phone an audible request to connect said wireless mobile phone to a party by name, and said apparatus further comprises means to offer to send said party's phone number to said wireless mobile phone.

32. The apparatus of claim 30, wherein said means to provide to said wireless mobile phone said party's phone number in a data form comprise means to send a data packet having said party's phone number as a part of a data payload portion of said data packet to said wireless mobile phone.

33. The apparatus of claim 32, wherein said data payload portion of said received data packet further includes identification information identifying said party as being affiliated with said included phone number.

34. The apparatus of claim 33, wherein said means to provide to said wireless mobile phone said party's phone number in a data form comprise means to encode said data packet among audio signals sent to said wireless mobile phone.

35. The apparatus of claim 32, wherein said means to provide to said wireless mobile phone said party's phone number in a data form comprises means to automatically establish another connection to said wireless mobile phone at a subsequent point in time after termination of the requested connection to said party, and provide said data packet over said subsequent automatically established other connection.

36. The apparatus of claim 30, wherein said means to provide to said wireless mobile phone said party's phone number in a data form to allow said wireless mobile phone to save said party's phone number comprises
a transmitter to transmits signals;
a storage medium having stored therein a plurality of programming instructions designed to retrieve said party's phone number from a directory database, and send said party's phone number to said wireless mobile phone through said transmitter; and
a processor coupled to said transmitter and said storage medium to execute said programming instructions.

37. The apparatus of claim 36, wherein said storage medium further having stored therein said directory database.
